(19) United States
(12) Patent Application Publication
(10) Pub. No.: US 2007/0003446 A1
(43) Pub. Date: Jan. 4, 2007

(54) Apparatus for producing probe carrier and method of producing the same including process of quality assurance therefor

(75) Inventors: Kazuaki Takahata, Tokyo (JP); Tohru Ishibashi, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/472,343

(22) Filed: Jun. 22, 2006

(30) Foreign Application Priority Data
Jun. 30, 2005 (JP) 2005-192085

(51) Int. Cl. B01L 3/00

(52) U.S. Cl. 422/100; 436/180

(57) ABSTRACT

The conditions of a liquid-droplet spot formed on a carrier are measured and then compared with known data to easily determine the conditions of a probe, such as the presence or absence of the probe in the liquid-droplet spot and the concentration thereof.

### BACKGROUND OF THE INVENTION

1. Field of the Invention

The present invention relates to a method of producing a probe carrier on which a probe is immobilized, which includes the step of quality assurance for the probe carrier, and to an apparatus for producing the same.

2. Related Background Art

As one of technologies for carrying out, for example, prompt and precise determination of a nucleic acid base sequence, detection of a target nucleic acid in a sample, identification of various bacterial species, a wide variety of detection methods using probe arrays have been known in the art. The probe array is constructed of a number of so-called probes, which can be specifically bound to target nucleic acids, arranged on a solid phase.

As a typical method of producing such a probe array, for example, U.S. Pat. No. 5,424,186 describes a method of producing DNA probes in array form, in which the DNA probes each have different base sequences, by a sequential elongation reaction of DNA on a solid phase substrate using photolithography with a photodegradable protective group. By using the method, it is possible to make a DNA probe array, on which 10,000 different DNAs having their own sequences are mounted per square centimeter. Furthermore, in this method, a photolithographic process is carried out using a photomask dedicated for each of four different bases (A, T, C, and G) when DNA is synthesized by a sequential elongation reaction to allow any of bases to be selectively elongated on a predetermined portion of the array. Therefore, the process permits the synthesis of a plurality of different DNAs each having desired base sequences in their predetermined positions on the substrate.

As an alternative method, there is a method of producing a probe array such that DNAs for probes are prepared and purified in advance, the base lengths of the DNAs are confirmed as required, and the DNAs are then provided on a substrate. The supply of DNAs to the substrate may be carried out using a device such as a micro dispenser. Furthermore, the International Publication No. WO95/35505 describes an approach to supply DNAs to a membrane using capillaries. In principle, by the application of such an approach, the production of a DNA array having about 1,000 spots per square centimeter can be allowed. Basically, the approach supplies a probe solution to a predetermined position on a substrate using a single capillary dispenser device for every probe. By repeating the operation of supply, each probe can be arranged on the substrate.

For supplying different drug solutions to the respective wells of a 96-well or 384-well microplate, which is used for high-throughput screening of drugs, a dedicated micro-dispenser device is also commercially available from, for example, Robbins Scientific Co., Ltd., under the trade name of Hydra™. This is basically composed of a two-dimensional arrangement of microsyringes with a minimum discharge volume of 100 nl.

As another approach, there is also proposed an approach to supply a solution, which contains materials desired for the synthesis of DNA, by means of an ink-jet method for every elongation stage when the solid-phase synthesis of DNA is carried out on a substrate. For instance, EP Patent No. 0703825 describes a method for the solid-phase synthesis of a plurality of DNAs each having predetermined base sequences by supplying nucleotide monomers and activators from different piezo-jet nozzles to a solid phase for synthesis. The supply (coating) by means of the ink-jet method is excellent in reliability, such as reproductivity of the amount supplied, and available in microfabrication of nozzles, while having features suitable for densification of probe arrays as compared to the supply (coating) with the above-described capillaries.

In general, when the probe array produced by any of the above methods is used in any of the applications described above, it is important to know an immobilization density, i.e., the amount of a probe on an immobilization area (also referred to as a spot or dot), which is separated from other probes in the same matrix, for assuring the reliability of an analysis. In addition, depending on an analysis device or analysis method to be applied on an array, it may be also important to know (image) what kind of a matrix configuration (shape, size, and condition) the probes actually have. Furthermore, considering the supply of a number of probe arrays, for securing the reliability of analysis, it is extremely important to grasp unevenness in a production lot or between production lots with respect to the quantities of probes resided in each matrix and to grasp purities thereof.

By the way, when DNAs for probes are synthesized, purified, and supplied to a substrate, the purities and concentrations of DNAs are determined before supplying them to the substrate to confirm the quantities of probes supplied on the substrate. The purity of a component in a probe solution can be determined by means of high performance liquid chromatography (HPLC), liquid chromatography—mass spectroscopy (LC-MS) using a gravimetric analyzer as a detector for liquid chromatography, matrix-assisted laser desorption ionization time-of-flight mass spectroscopy (MALDI) method, or the like.

On the other hand, on a probe-fixing carrier, so-called a probe array in general, from several to several tens of thousands of probes can be immobilized depending on application. For measuring the concentrations of the respective probes on the carrier, the measurements in large numbers should be carried out. Considering such a fact, in the case of a probe array, the probe concentration in a probe medium (probe solution) is measured in an applicator for applying the probe medium on a solid phase substrate or in a dispensing device for supplying the probe medium to the applicator.

Japanese Patent Application Laid-open No. 2003-063013 discloses an ink-jet head equipped with a light-emitting device and a light-receiving device. When an oligonucleotide or DNA such as cDNA is used as a probe, light at a wavelength of 260 nm is emitted from the light-emitting device to the probe and then received by the light-receiving device to determine the optical density of the probe. From the optical density of probe thus obtained, the probe concentration is determined, thereby allowing the measurements of several kinds of probe media to be carried out. The conversion from the absorbance to the concentration should be carried out in advance because the probes have their own different molar absorbance coefficients.

Furthermore, it is possible to determine the probe concentration in a probe solution in a multi-well plate in which a plurality of probe media is stored or during the step of dispensing the probe solution into the wells of the multi-well plate for the like. In this way, the amount of probe can be confirmed by determining the probe concentration solution before spotting on a substrate.

### SUMMARY OF THE INVENTION

It is considerably time-consuming operation to determine and verify the concentration or the like of each of various probe solutions. Furthermore, under ordinary circumstances, it may be important to confirm the amount of the probe obtained from the probe solution actually supplied on the substrate. Nevertheless, no convenient apparatus and method of measuring a minute amount of a probe solution supplied (e.g., as little as several pico-liters when supplied by ink-jet) have not been found in the art.

The present invention intends to solve the problems with the prior art as described above. An object of the present invention is to provide a technology for effectively determining the probe concentration in a spot formed on a carrier by simple operation when a probe carrier on which different probes are immobilized on a carrier is produced.

The inventors of the present invention have intensively studied for solving the above problems. As a result, the inventors of the present invention have found out that the presence or absence of probe and the concentration thereof in a probe solution can be determined, by using a carrier having a hydrophobic surface without water-absorption property for detection, on the basis of the conditions of a spot being formed, when a spot of a probe solution is formed on the surface of the carrier. To be specific, it is found that when the area or spot diameter that consists of a liquid droplet on the carrier is measured using a laser microscope, the spot area or spot diameter of a probe-containing solution is larger than that of a probe-free solution. In addition, when the contact angle of spot is determined by calculation based on the measurement on the shape of spot using a three-dimensional microscope, the probe-containing solution has a smaller contact angle of spot as compared to that of the probe-free solution. From those facts, the inventors of the present invention have found that the probe concentration can be easily determined by utilizing data that represents the conditions of spot consisting of a probe solution supplied on a substrate, thereby completing the present invention.

The present invention relates to an apparatus for producing a probe carrier having a probe immobilized thereon, the probe being capable of specifically binding to a target substance, comprising:

a probe solution-imparting means for imparting a probe solution on a predetermined position of a carrier to form a liquid-droplet spot;

a measuring means for measuring conditions of the liquid-droplet spot on the carrier; and

a determining means for determining conditions of the probe solution that forms the liquid-droplet spot on the basis of the conditions of the liquid-droplet spot measured by the measuring means.

Further, the present invention relates to a method of producing a probe carrier by spotting a probe solution containing a probe on a carrier, the probe being capable of specifically binding to a target substance, comprising:

an imparting step for imparting a probe solution on a carrier to form a liquid-droplet spot;

a measuring step for measuring conditions of the liquid-droplet spot formed on the carrier; and

a determining step for determining conditions of the probe solution that forms the liquid-droplet spot on the basis of the conditions of the liquid-droplet spot.

According to the present invention, the conditions (e.g., the area or spot diameter or the contact angle) of a liquid-droplet spot consisting of a probe solution on a substrate can be determined by a measurement using, for example, a laser microscope mounted on an apparatus for producing a probe carrier. Any information obtained by the measurement may be used to easily determine the presence or absence of probe or the concentration thereof in a spot of liquid droplet in a short time. By providing such a determination operation, the qualities of probe carrier produced can be verified. Particularly, the presence or absence of probe in the solution can be confirmed. Therefore, the apparatus for producing a probe carrier and the method of producing the same according to the present invention can be suitably employed for an improvement in qualities in the production of a probe carrier.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a graphical representation of the relationship between the probe concentration and the spot area;

FIG. 2 is a graphical representation of the relationship between the probe concentration and the spot diameter;

FIG. 3 is a graphical representation of the relationship between the probe concentration and the spot area;

FIG. 4 is a graphical representation of the relationship between the probe concentration and the spot diameter;

FIG. 5 is a graphical representation of the relationship between the probe concentration and the spot area; and

FIG. 6 is a schematic diagram illustrating an exemplified configuration of the apparatus for producing a probe carrier.

### DESCRIPTION OF THE PREFERRED EMBODIMENTS

Preferred embodiments of the present invention will now be described in detail in accordance with the accompanying drawings.

Hereinafter, the apparatus and the method of producing a probe carrier of the present invention will be more specifically described.

A carrier for immobilizing probes is not particularly limited as far as it is able to immobilize probes thereon and allows the probe-immobilized carrier thus obtained to detect or separate a target substance without any trouble while being capable of forming a condition-measurable liquid-droplet spot on the surface of the substance. For preparing a probe array, in consideration of the adaptability and versatility of carrier to a target substance, the carrier is preferably a glass substrate or a plastic substrate. Particularly preferable is an alkali-free glass substrate, a quartz substrate, or the like, having a probe-immobilizing hydrophobic surface without water-absorption property. Among them, it is preferable to select a carrier that allows the conditions of a liquid-droplet spot to vary within a detectable range depending on a difference in probe concentrations and the presence or absence of probes when the liquid-droplet spot is formed using a standard probe solution of known concentration or an aqueous medium for preparing the probe solution.

For immobilizing probes on carriers, various methods have been known in the art. If the probes are DNAs, for example, there are an immobilizing method where a DNA synthesis is carried out while one end of DNA is immobilized on the surface of a carrier, a transfer method where previously-prepared DNA is transferred to a carrier using pins or stamping, and another immobilizing method where previously-prepared DNA is imparted on a carrier using an ink-jet technology or the like.

Probes can be selected from DNAs, proteins, synthetic chemicals, and so on, depending on the kinds of target substances.

As the immobilizing method where a DNA synthesis is carried out on a carrier, for example, a method described in U.S. Pat. No. 5,143,854 has been known in the art. According to this synthetic method, polymers having various sequences are synthesized on a substrate provided as a carrier by allowing an activator to remove a protective group from a selected area on the substrate, coupling a monomer having a removable protective group with the area, and repeating the precedent steps.

Furthermore, as the method of imparting a biologically active substance, such as previously-prepared DNA or the like, on a carrier to immobilize it thereon, for example, a method described in Japanese Patent Application laid-open No. H08-023975 has been known in the art. The method disclosed in this gazette allows the reaction of a biologically active substance having reactivity to a carbodiimide group with an immobilizing material consisting of a high-molecular compound having a carbodiimide group supported on a substrate provided as a carrier to immobilize the above substance on the carrier.

Furthermore, as described in Japanese Patent Application laid-open No. H08-334509, there is a known method where the biologically active substance is detected such that the substance is immobilized on a carbodiimide-containing compound through the carbodiimide group thereof and then detected.

Furthermore, in Japanese Patent Application laid-open No. 2001-178442, a method of bonding a DNA fragment to a carrier through a thiol group is disclosed. In this method, at first, a solid-phase substrate, on which one end of a chain molecule having a reactive substituent capable of forming a covalent bond by reacting with a thiol group is immobilized, is prepared. Subsequently, a DNA fragment having a thiol group on its end portion is brought into contact with the solid-phase substrate in liquid phase, thereby immobilizing the DNA fragment on the solid-phase substrate. In this case, the DNA fragment is covalently bound to the chain molecule, so that the DNA fragment can be immobilized on the surface of the solid-phase substrate. Further, in the gazette, as the reactive substituent, which may react with a thiol group to form a covalent bond, a substituent containing a group selected from the group consisting of a maleimidyl group, an α- or β-unsaturated carbonyl group, an α-halocarbonyl group, an a halogenated alkyl group, an aziridine group, and a disulfide group is described.

As the method of immobilizing probes on a carrier, as described above, many methods have been known in the art even in the method of immobilizing DNA fragments as described above. Thus, probes can be immobilized on the surface of a carrier by a method suitably selected from these methods. Here, the kinds of probes and the immobilization mechanisms thereof, which can be used in the present invention, are not particularly limited.

On the other hand, as the method of imparting a probe solution on a carrier, a method disclosed in Japanese Patent Application laid-open No. H11-187900 A, such as one using an ink-jet method or a pin method, can be employed. In this case, basic groups are arranged on the surface of a carrier, so that probes reactive to these basic groups can be effectively immobilized on the carrier.

For the spotting method, among the above-mentioned method, particularly an ink-jet method can be particularly suitable for quick, precise spotting at high density. The term “ink-jet method” means a liquid-imparting method where a probe solution is placed in a minute nozzle, the near-tip portion of the nozzle is instantaneously pressurized or heated to allow a minute amount of the probe solution to be precisely ejected from the tip of the nozzle to the surface of a carrier and attached thereon. The probe solution used in the above spotting method with the ink-jet technology contains additional components other than probes. Such components are not particularly limited as far as they allow the probe solution to be spotted as desired. Specifically, preferable components are those which do not substantially affect on probes upon ejection of liquid droplets while permits the ejection in a predetermined amount at a desired position on the carrier. Further, it is preferable that components are capable of forming a condition-measurable solution spot on the carrier. For instance, in the case of a bubble-jet head having equipped with a mechanism for ejecting a liquid droplet by imparting thermal energy on a probe solution, the other component may be an aqueous medium containing both water and an aqueous organic solvent. Examples of the aqueous organic solvent include glycerin, thiodiglycol, isopropyl alcohol, and acetylene alcohol. More specifically, a preferable aqueous medium contains 5 to 30% by weight of glycerin, 5 to 15% by weight of thiodiglycol, and 0.02 to 5% by weight of isopropyl alcohol or acetylene alcohol in water.

The probe solution thus obtained is ejected from an ink-jet head and attached to the carrier configured as described above. In this case, a liquid droplet attached on the carrier forms a spot (liquid-droplet spot) thereon in the form of a circle (the shape of a region contacted with the surface of the carrier). Besides, a ejected area does not broaden. When the probe solution is spotted at high density, furthermore, the resulting spot can be effectively prevented from combining with the adjacent spot.

Items for the measurement, which are preferable for the forming conditions of a liquid-droplet spot formed from a probe solution, include:

(1) the area of a liquid-droplet spot (the area of a contact region (typically in a circle form) contacted with the surface of carrier);

(2) the diameter of a liquid-droplet spot (the diameter of a circular contact region contacted with the surface of carrier); and

(3) the contact angle of a liquid-droplet spot with respect to the surface of carrier.

Both the area and diameter of a liquid-droplet spot may be measured by, for example, a laser microscope mounted on a spotting device. In addition, the contact angle of a liquid-droplet spot may be calculated from the configuration of a spot on a carrier after measuring the configuration of the spot sterically using a three dimensional microscope, or the like.

As described above, the type of the carrier and the composition of the probe solution may be selected so that the above items can be measured. For instance, in the configuration, or the like in the examples described later, the method or apparatus may be adjusted to form a spot of 1,200 to 3,200 μm² in area, 40 to 60 μm in diameter, and 30° or more in contact angle.

A method of determining the probe concentration or the presence or absence of a probe from the formation conditions of a liquid-droplet spot formed on a carrier is preferably one that makes a comparison between information (data) for at least one of physical items (1) to (3) described above and information (data) obtained only from a probe solution of known concentration or an aqueous medium. For instance, the probe concentration and the presence of probe can be confirmed by determining whether the area or diameter of a liquid-droplet spot becomes large while the contact angle thereof becomes small. Here, it is preferable to measure the area, diameter, or contact angle of the liquid-droplet spot at high accuracy. Therefore, a measuring apparatus and method are not particularly limited, so that any of those known in the art may be used.

An example of the probe-manufacturing apparatus of the present invention is schematically shown in FIG. 6. The apparatus has: a carrier-retaining means 3 for retaining a carrier 1 on which liquid-droplet spots 2 are formed; a probe solution-imparting means 4 and 5 for forming liquid-droplet spots 2 on the surface of the carrier 1; a measuring means 6 for measuring the conditions of liquid-droplet spots 2 on the carrier 1; and a determining means 7 for determining the conditions of a probe solution that forms the liquid-droplet spots based on the conditions of liquid-droplet spots measured by the measuring means. The measuring means 6 includes a physical properties measuring means for measuring at least one of the area (spot area) or diameter (spot diameter) of a liquid-droplet spot 2 that occupies the contact region with the surface of the carrier 1 and the contact angle of the liquid-droplet spot 2 with respect to the surface of the carrier 1. The determining means 7 is configured so that it makes a comparison between known-sample data from a memory where data obtained from known samples are stored and a measurement result obtained by the measuring means 6 and then the presence or absence of probe, or the probe concentration in the liquid-droplet spot 2 is determined.

Furthermore, the probe solution-imparting means is constructed of an imparting unit 4 responsible for imparting a probe solution to a predetermined position on the surface of the carrier 1 and a control unit 5 responsible for controlling the position as well as the timing of imparting the probe solution.

The probe solution-imparting means used may be one of the follows:

(1) a liquid-imparting means with an ink-jet method;

(2) a liquid-imparting means having a storage part for storing a probe solution, a pin having a tip for contacting with the liquid surface of the storage part to attach a predetermined amount of the probe solution by contacting with the liquid surface, and a pin position control means for transferring and supplying the solution attached on the tip of the pin to the surface of a carrier 1 by contacting physically the tip of the pin with the surface of the carrier 1;

(3) a liquid-imparting means having a storage part for storing a probe solution, a capillary tube having a tip for contacting with the liquid surface of the storage part to include a predetermined amount of the probe solution by contacting with the liquid surface, and capillary-tube position control means for supplying the solution included in the capillary tube to the surface of a carrier 1 by contacting physically the tip of the capillary-tube with the surface of the carrier 1; and the like.

The imparting means 4 and the carrier 1 are controlled to change their positions relatively, so that a liquid-droplet spot 2 can be formed on a predetermined position on the surface of the carrier 1 and located at a position where the conditions of the liquid-droplet spot cannot be prevented upon measurement.

As described above, the measuring means 6 used may be preferably one having a laser microscope or three-dimensional microscope.

The present apparatus may be designed to automatically determine the probe concentration, or the presence or absence of probe contained. For instance, data previously obtained from a standard sample, including the area, diameter, contact angle, and the like of a liquid-droplet spot are stored in the memory 8. Upon determination, the stored date is brought up to an operation part of a computer constructing the determining means according to operation programmed in advance. Then, the data is compared with data (e.g., imaged data) which is actually obtained by the measuring means 6 from the surface of the carrier 1 by automatically read out. From the results of the comparison, the probe concentration, or the presence or absence of probe contained can be determined.

As a result of the determination, if there is a liquid-droplet spot that does not reach to a predetermined probe concentration or there is a liquid-droplet spot in the absence of probe contained, the corresponding probe array is pulled out to avoid an inferior product to be incorporated.

Alternatively, as a result of the determination, if there is a liquid-droplet spot that does not reach to a predetermined probe concentration or there is a liquid-droplet spot in the absence of probe contained, a re-conditioned probe solution is supplied to the probe-solution imparting means and the corresponding spotting position is subjected to spotting again to thereby attain a predetermined probe concentration. The probe solution to be re-conditioned may be supposed that a liquid droplet to be spotted from the liquid-droplet imparting means is of a constant amount. The probe solution may be adjusted so that the concentrations of probe determined on the surface of the carrier and a liquid droplet to be re-spotted finally reach to a predetermined concentration on the carrier.

Likewise, the results of the determination are feed back to the manufacturing apparatus, thereby allowing the production of a good probe array while attaining an improvement in yield rate.

Hereinafter, the present invention will be described more specifically by means of the following examples. Here, the examples described below intend to be those of the best mode of the present invention but not intend to be limited to these examples.

### EXAMPLE 1

(1) Preparation of detection substrate

A slide glass provided as a carrier was dipped for 10 minutes in a 1 mol/l sodium hydroxide aqueous solution previously warmed at 60° C. Then, the slide glass was sufficiently washed with running purified water to wash out sodium hydroxide attached thereon, thereby removing sodium hydroxide. After sufficient rinsing, the slide glass was dipped in pure water and ultrasonic cleaning was then carried out for 10 minutes. After the ultrasonic cleaning, the slide glass was sufficiently washed with running purified water to wash out particles attached on the slide glass, thereby removing the particles. Subsequently, the slide glass was dried with spin drying.

An aminosilane coupling agent (trade name: KBM-903, manufactured by ShinEtsu Chemical Co., Ltd.) was dissolved so as to be of 1% by weight and then stirred for 30 minutes, thereby obtaining an aqueous solution. Subsequently, the slide glass was dipped in the aqueous solution for 30 minutes and then pulled out of the aqueous solution, followed by washing with water. Then, the slide glass was placed in an oven and dried for 1 hour at 120° C. in oven.

(2) Synthesis of probe

Used as a probe was a single-stranded nucleic acid having a base sequence complementary with the whole or part of the target nucleic acid to be detected and allowing the target nucleic acid to be detected by specifically hybridizing with the base sequence of the target nucleic acid. A DNA-automatic synthesizer was used to synthesize a single-stranded DNA fragment of the following structure having a sequence represented by SEQ ID No. 1.
5′HS—(CH₂)₆-O-PO₂-O-ACTGGCCGTCGTTTTACA3′

Here, a mercapto group was introduced to the end of the single-stranded DNA using Thiol-Modifier (manufactured by GlenResearch Co., Ltd.) when the synthesis was carried out by a DNA automatic synthesizer. Subsequently, a normal deprotection was carried out. Then, the DNA was collected and then purified with high-speed liquid chromatography, followed by using it the experiment described below.

(3) Solution for dissolving probe

As an aqueous medium which can be normally ejected on a carrier using an ink-jet head, an aqueous medium consisting of 30% by weight of glycerin, 4% by weight of isopropyl alcohol, and 0.1% by weight (the rest: water) of acetylene alcohol (trade name: Acethylenol E100, manufactured by Kawaken Fine Chemicals, Co., Ltd.) was used.

(4) Immobilization of probe

The single-stranded DNA fragment synthesized in the above (2) was dissolved in the aqueous medium of the above (3) to prepare each of 1 μM, 2 μM, 4 μM, 8 μM, 10 μM, and 20 μM DNA fragment-containing aqueous solutions.

The DNA-containing aqueous solutions and an aqueous medium (not containing DNA fragments) were spotted on a slide glass prepared by the method of the above (1), respectively using a bubble-jet printer. All of the samples had the same amount of a liquid droplet per spot to be formed.

(5) Measurements of spot area and spot diameter

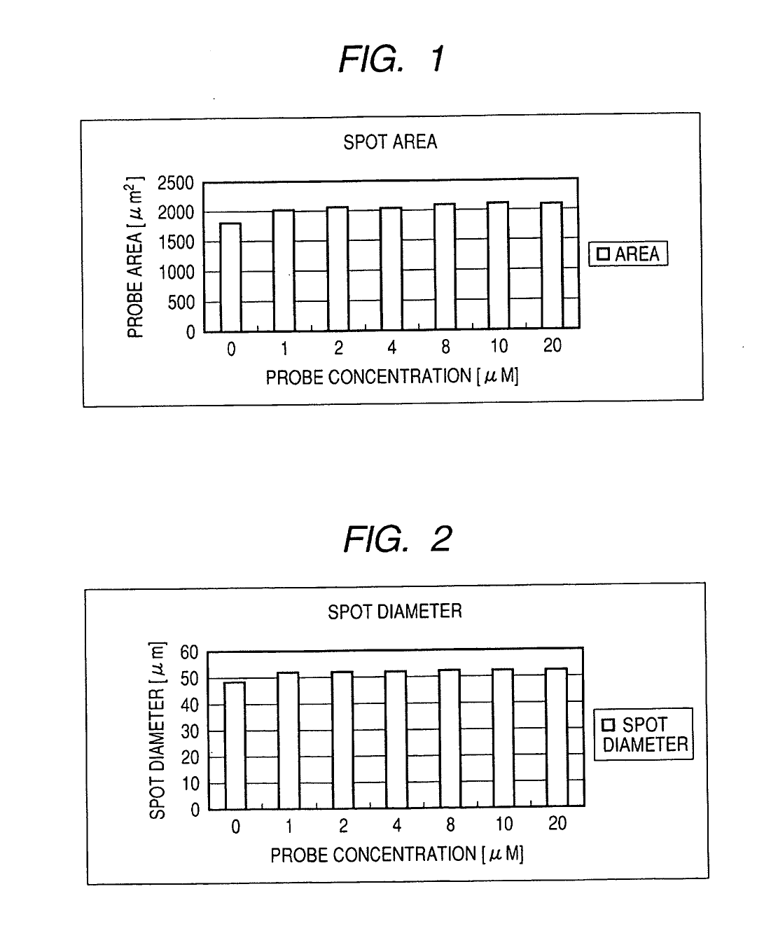

The slide glass on which the liquid-droplet spots were formed in the above (4) was held at a predetermined position in a measuring apparatus constructed of a glass-substrate planimeter (made up of: an image-processing device (SoftWorks Co., Ltd.), a CCD camera (Flovel, AD-520), a microscope L200A+Auto-focus unit (Sankei Co., Ltd.), and a stage and jig (Azumino Sekkei-shitsu KK.). Subsequently, the areas and diameters of spots were then measured, respectively. The measurement results of spot areas were shown FIG. 1 and the measurement results of spot diameters were shown in FIG. 2. From the results shown in FIG. 1, the DNA fragment-containing aqueous solution had an area of about 2,000 to 2,100 μm² within the spotted concentrations thereof. On the other hand, the DNA fragment-free aqueous medium had an area of about 1,800 μm². In addition, from the results of FIG. 2, the DNA fragment-containing aqueous solution had a spot diameter of about 51 to 52 μm within the spotted concentration range thereof. On the other hand, the DNA fragment-free aqueous solution had a spot diameter of about 48 μm. Consequently, the DNA fragment-containing aqueous solution was different from the DNA fragment-free aqueous medium with respect to both the spot area and the spot diameter, which were spotted on the slide glass. Therefore, by making a comparison between them, a determination of whether the probe was present or not in the solution could be determined.

From the operation as described above, it is possible to easily confirm the presence or absence of probe, or the concentration thereof with a liquid-droplet spot formed from a liquid droplet of a probe solution imparted on a carrier. The confirmed liquid-droplet spot is subjected to a treatment for immobilization, such as a drying treatment, thereby providing a quality-assured probe carrier.

### EXAMPLE 2

(1) Preparation of detection substrate

A slide glass provided as a carrier was dipped for 10 minutes in a 1 mol/l sodium hydroxide aqueous solution previously warmed at 60° C. Then, the slide glass was sufficiently washed with running purified water to wash out sodium hydroxide attached thereon, thereby removing sodium hydroxide. After sufficient rinsing, the slide glass was dipped in pure water and ultrasonic cleaning was then carried out for 10 minutes. After the ultrasonic cleaning, the slide glass was sufficiently washed with running purified water to wash out particles attached on the slide glass, thereby removing the particles. Subsequently, the slide glass was dried with spin drying.

An aminosilane coupling agent (trade name: KBM-903, manufactured by ShinEtsu Chemical Co., Ltd.) was dissolved so as to be of 1% by weight and then stirred for 30 minutes, thereby obtaining an aqueous solution. Subsequently, the slide glass was dipped in the aqueous solution for 30 minutes and then pulled out of the aqueous solution, followed by washing with water. Then, the slide glass was placed in an oven and dried for 1 hour at 120° C. in oven.

(2) Probe

A probe used was BSA (bovine serum albumin).

(3) Solution for dissolving probe

As an aqueous medium which can be normally ejected on a carrier using an ink-jet head, an aqueous medium consisting of 30% by weight of glycerin and 4% by weight (the rest: water) of isopropyl alcohol was used.

(4) Immobilization of probe

The BSA of the above (2) was dissolved in the aqueous medium of the above (3) to prepare each of 0.1 mg/ml and 1 mg/ml BSA-containing aqueous solutions.

The BSA-containing aqueous solutions and an aqueous medium (not containing BSA) were spotted on a slide glass prepared by the method of the above (1), respectively using a bubble-jet printer. All of the samples had the same amount of a liquid droplet per spot to be formed.

(5) Measurements of spot area and spot diameter

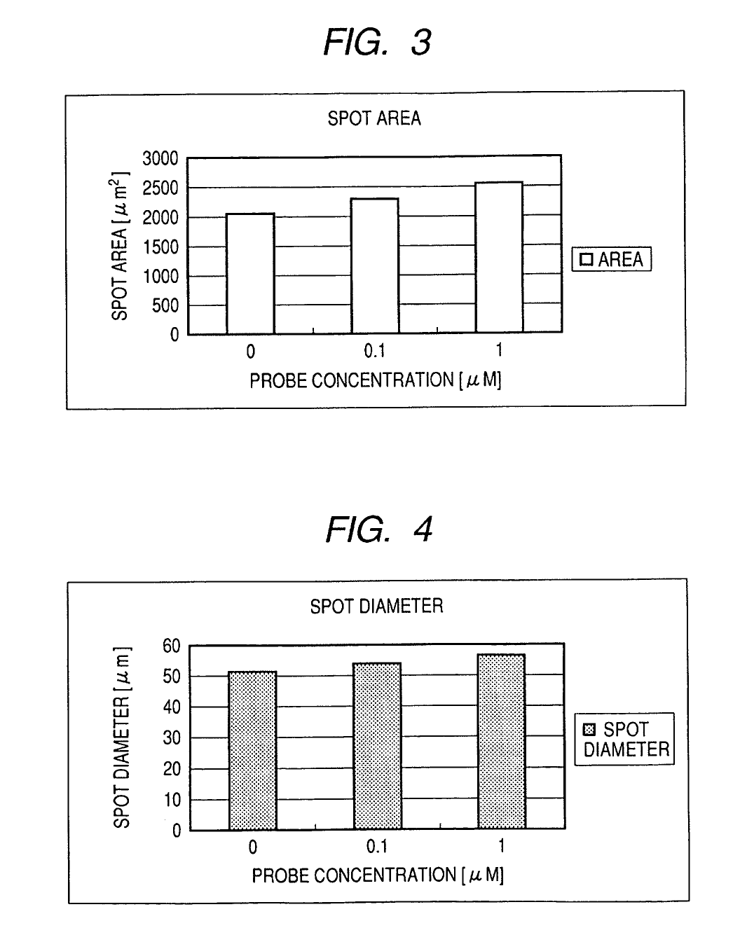

The slide glass on which the liquid-droplet spots were formed in the above (4) was held at a predetermined position in a measuring apparatus constructed of a glass-substrate planimeter (made up of: an image-processing device (SoftWorks Co., Ltd.), a CCD camera (Flovel, AD-520), a microscope L200A+Auto-focus unit (Sankei Co., Ltd.), and a stage and jig (Azumino Sekkei-shitsu KK.). Subsequently, the areas and diameters of spots were then measured, respectively. The measurement results of spot areas were shown FIG. 3 and the measurement results of spot diameters were shown in FIG. 4. From the results shown in FIG. 3, the BSA-containing aqueous solution had an area of about 2,200 to 2,500 μm² within the spotted concentrations thereof. On the other hand, the BSA-free aqueous medium had an area of about 2,000 μm² within the spotted concentrations thereof. In addition, from the results of FIG. 4, the BSA-containing aqueous solution had a spot diameter of about 54 to 55.5 μm within the spotted concentration range thereof. On the other hand, the BSA-free aqueous solution had a spot diameter of about 51.5 μm. Consequently, the BSA-containing aqueous solution was different from the BSA-free aqueous medium with respect to both the spot area and the spot diameter. In addition, within the concentration range of spot, the linearity between the concentration and the spot area, or spot diameter was observed. Therefore, by making a comparison between them, a determination of whether the probe was present or not in the solution could be determined.

From the operation as described above, it is possible to easily confirm the presence or absence of probe, or the concentration thereof with a liquid-droplet spot formed from a liquid droplet of a probe solution imparted on a carrier. The confirmed liquid-droplet spot is subjected to a treatment for immobilization, such as a drying treatment, thereby providing a quality-assured probe carrier.

### EXAMPLE 3

(1) Preparation of detection substrate

A slide glass provided as a carrier was dipped for 10 minutes in a 1 mol/l sodium hydroxide aqueous solution previously warmed at 60° C. Then, the slide glass was sufficiently washed with running purified water to wash out sodium hydroxide attached thereon, thereby removing sodium hydroxide. After sufficient rinsing, the slide glass was dipped in pure water and ultrasonic cleaning was then carried out for 10 minutes. After the ultrasonic cleaning, the slide glass was sufficiently washed with running purified water to wash out particles attached on the slide glass, thereby removing the particles. Subsequently, the slide glass was dried with spin drying.

An aminosilane coupling agent (trade name: KBM-903, manufactured by ShinEtsu Chemical Co., Ltd.) was dissolved so as to be of 1% by weight and then stirred for 30 minutes, thereby obtaining an aqueous solution. Subsequently, the slide glass was dipped in the aqueous solution for 30 minutes and then pulled out of the aqueous solution, followed by washing with water. Then, the slide glass was placed in an oven and dried for 1 hour at 120° C. in oven.

(2) Synthesis of probe

A probe used was a single-stranded nucleic acid having a base sequence complementary with the whole or part of a target nucleic acid to be detected and allowing the target nucleic acid to be detected by specifically hybridizing with the base sequence of the target nucleic acid. A DNA-automatic synthesizer was used to synthesize a single-stranded DNA fragment of the following structure having a sequence represented by SEQ ID No. 1.
5′HS-(CH₂)₆-O-PO₂-O-ACTGGCCGTCGTTTTACA3′

Here, a mercapto group was introduced to the end of the single-stranded DNA using Thiol-Modifier (manufactured by GlenResearch Co., Ltd.) when the synthesis was carried out by a DNA automatic synthesizer. Subsequently, a normal deprotection was carried out. Then, the DNA was collected and then purified with high-speed liquid chromatography, followed by using in the experiment described below.

(3) Solution for dissolving probe

As an aqueous medium which can be normally ejected on a carrier using an ink-jet head, an aqueous medium consisting of 30% by weight of glycerin, 4% by weight of isopropyl alcohol, and 0.01% by weight (the rest: water) of acetylene alcohol (trade name: Acethylenol E100, manufactured by Kawaken Fine Chemicals, Co., Ltd.) was used.

(4) Immobilization of probe

The single-stranded DNA fragment synthesized in the above (2) was dissolved in the aqueous medium of the above (3) to prepare each of 0.001 μM, 0.01 μM, 0.05 μM, 0.1 μM, 0.5 μM, 1 μM, and 10 μM DNA fragment-containing aqueous solutions.

The DNA-containing aqueous solutions and an aqueous medium (not containing DNA fragments) were spotted on a slide glass prepared by the method of the above (1) using a bubble-jet printer, respectively. All of the samples had the same amount of a liquid droplet per spot to be formed.

(5) Measurements of spot area and spot diameter

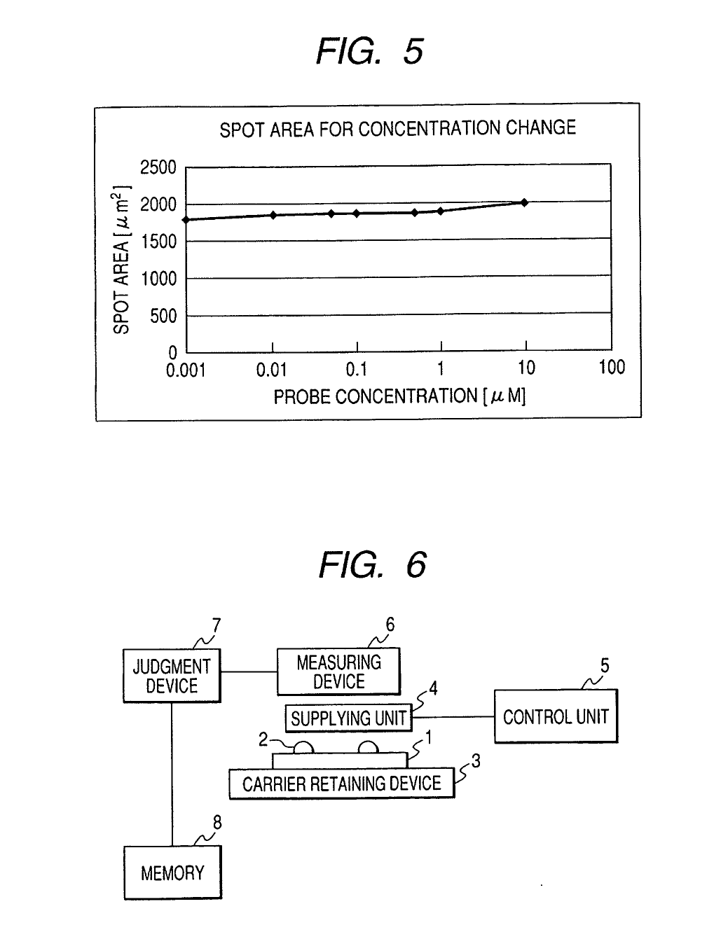

The slide glass on which the liquid-droplet spots were formed in the above (4) was held at a predetermined position in a measuring apparatus constructed of a glass-substrate planimeter (made up of: an image-processing device (SoftWorks Co., Ltd.), a CCD camera (Flovel, AD-520), a microscope L200A+Auto-focus unit (Sankei Co., Ltd.), and a stage and jig (Azumino Sekkei-shitsu KK.). Subsequently, the areas of spots were then measured. The measurement result of spot areas was shown FIG. 5. FIG. 5 was used as a calibration curve within the concentration range of spot.

(6) Measurement of the concentration of spot solution

Three different solutions, an aqueous solution 1, an aqueous solution 2, and an aqueous solution 3, in each of which the single-stranded DNA fragment synthesized in the above (2) was dissolved in the aqueous medium of the above (3), were prepared, respectively.

Each of these DNA fragment-containing solutions was spotted on the slide glass prepared by the method of the above (1) using a bubble-jet printer. All of the samples had the same amount of a liquid droplet per spot to be formed.

The slide glass on which the liquid-droplet spots were formed in the above (4) was held at a predetermined position in a measuring apparatus constructed of a glass-substrate planimeter (made up of: an image-processing device (SoftWorks Co., Ltd.), a CCD camera (Flovel, AD-520), a microscope L200A +Auto-focus unit (Sankei Co., Ltd.), and a stage and jig (Azumino Sekkei-shitsu KK.). Subsequently, the areas of spots were then measured, respectively.

From the results of the measurements, the area of the aqueous solution 1 containing the DNA fragment was about 1,850 μm². In addition, the area of the aqueous solution 2 containing the DNA fragment was about 1,950 μM². Furthermore, the area of the aqueous solution 3 containing the DNA fragment was about 1,750 μm².

From the spot areas of the respective aqueous solutions 1, 2, and 3, the concentrations of the respective aqueous solutions 1, 2, and 3 were calculated from FIG. 5. Consequently, the concentration of the aqueous solution 1 was 0.01 μM, the concentration of the aqueous solution 2 was 5 μM, and the concentration of the aqueous solution 3 was 0.001 μM.

Furthermore, the absorbances of the respective aqueous solutions 1, 2, and 3 spotted on the substrate were measured and the probe concentrations thereof were then calculated from the absorbances densities obtained. Consequently, the concentration of the aqueous solution 1 was about 0.01 μM, the concentration of the aqueous solution 2 was about 5 μM, and the concentration of the aqueous solution 3 was about 0.001 μM. These concentrations obtained were almost the same as those calculated from the spot areas in FIG. 5. Thus, the concentrations of the aqueous solutions spotted were calculated from the spot areas, respectively.

From the operation as described above, it is possible to easily confirm the presence or absence of probe, or the concentration thereof with a liquid-droplet spot formed from a liquid droplet of a probe solution imparted on a carrier. The confirmed liquid-droplet spot is subjected to a treatment for immobilization, such as a drying treatment, thereby providing a quality-assured probe carrier.

The present invention is not limited to the above embodiments and various changes and modifications can be made within the spirit and scope of the present invention. Therefore to apprise the public of the scope of the present invention, the following claims are made.

This application claims priority from Japanese Patent Application No. 2005-192085 filed on Jun. 30, 2005, which is hereby incorporated by reference herein.

What is claimed is:

1. An apparatus for producing a probe carrier having a probe immobilized thereon, the probe being capable of specifically binding to a target substance, comprising:
a probe solution-imparting means for imparting a probe solution on a predetermined position of a carrier to form a liquid-droplet spot;
a measuring means for measuring conditions of the liquid-droplet spot on the carrier; and
a determining means for determining conditions of the probe solution that forms the liquid-droplet spot on the basis of the conditions of the liquid-droplet spot measured by the measuring means.

2. The apparatus for producing a probe carrier according to claim 1, further comprising:
a carrier-retaining means for retaining the carrier.

3. The apparatus for producing a probe carrier according to claim 1, wherein
the measuring means comprising a physical properties-measuring means for measuring at least one of an area or diameter of the liquid-droplet spot that occupies a contact region with a surface of the carrier and a contact angle of the liquid-droplet spot with respect to the surface of the carrier; and
the determining means comprises a contrastive determining means for determining a probe concentration of the probe solution that forms the liquid-droplet spot by making a comparison between information obtained from the physical properties-measuring means and previously-provided information.

4. The apparatus for producing a probe carrier according to claim 1, wherein
the measuring means comprises a physical properties-measuring means for measuring at least one of an area or diameter of the liquid-droplet spot that occupies a contact region with a surface of the carrier and a contact angle of the liquid-droplet spot with respect to the surface of the carrier; and
the determining means comprises a contrastive determining means for determining the presence or absence of probe in the probe solution that forms the liquid-droplet spot by making a comparison between information obtained from the physical properties-measuring means and previously-provided information.

5. The apparatus for producing a probe carrier according to claim 1, wherein
the probe solution-imparting means comprises a liquid-imparting means using an ink-jet method.

6. The apparatus for producing a probe carrier according to claim 1, wherein
the probe solution-imparting means comprises:
a storage part for storing the probe solution;
a pin having a tip for contacting with a liquid surface of the storage part to attach a predetermined amount of the probe solution; and
a pin position control means for transferring and supplying the probe solution attached on the tip of the pin to a surface of the carrier by physically contacting the tip of the pin with the surface of the carrier.

7. The apparatus for producing a probe carrier according to claim 1, wherein
the probe solution-imparting means comprises:
a storage part for storing the probe solution;
a capillary having a tip for contacting with a liquid surface of the storage part to include a predetermined amount of the probe solution; and
a capillary position control means for supplying the probe solution included in the capillary to a surface of the carrier by physically contacting the tip of the capillary with the surface of the carrier.

8. The apparatus for producing a probe carrier according to any one of claims 1 to 7, wherein
the probe is any one of a DNA, a protein, and a synthesized chemical substance.

9. The apparatus for producing a probe carrier according to any one of claims 1 to 7, wherein
the probe solution contains an aqueous medium, and
the carrier has a probe-immobilizing hydrophobic surface without water-absorption property.

10. A method of producing a probe carrier by spotting a probe solution containing a probe on a carrier, the probe being capable of specifically binding to a target substance, comprising:
an imparting step for imparting a probe solution on a carrier to form a liquid-droplet spot;
a measuring step for measuring conditions of the liquid-droplet spot formed on the carrier; and
a determining step for determining conditions of the probe solution that forms the liquid-droplet spot on the basis of the conditions of the liquid-droplet spot.

11. The method of producing a probe carrier according to claim 10, wherein
the measuring step comprises measuring at least one of physical properties including an area or diameter of the liquid-droplet spot that occupies a contact region with a surface of the carrier and a contact angle of the liquid-droplet spot with respect to the surface of the carrier; and
the determining step comprises determining a probe concentration of the probe solution that forms the liquid-droplet spot by making a comparison between information concerning physical properties and previously-provided information.

12. The method of producing a probe carrier according to claim 10, wherein
the measuring step comprises measuring at least one of physical properties including an area or diameter of the liquid-droplet spot that occupies a contact region with a surface of the carrier and a contact angle of the liquid-droplet spot with respect to the surface of the carrier; and
the determining step comprises determining the presence or absence of probe in the probe solution that forms the liquid-droplet spot by making a comparison between information concerning physical properties and previously-provided information.

13. The method of producing a probe carrier according to claim 10, wherein
the imparting step comprises imparting the probe solution on the carrier by an ink-jet method.

14. The method of producing a probe carrier according to claim 10, wherein
the imparting step comprises transferring and supplying a predetermined amount of the probe solution attached on a tip of a pin, where the tip is contacted with a liquid surface of a storage part for storing the probe solution, to a surface of the carrier by contacting the tip of the pin with the surface of the probe.

15. The method of producing a probe carrier according to claim 10, wherein
the imparting step comprises supplying a predetermined amount of the probe solution included in a capillary, in which the capillary is contacted with a liquid surface of a storage part for storing the probe solution, to a surface of the carrier by contacting a tip of the capillary with the surface of the probe.

16. The method of producing a probe carrier according to any one of claims 10 to 15, wherein
the probe is any one of a DNA, a protein, and a synthesized chemical substance.

17. The method of producing a probe carrier according to any one of claims 10 to 15, wherein
the carrier has a probe-immobilizing hydrophobic surface without water-absorption property.
